(19) United States
(12) Patent Application Publication
(10) Pub. No.: US 2025/0153716 A1
(43) Pub. Date: May 15, 2025

(54) VEHICLE MOVEMENT AMOUNT DETECTION DEVICE, AND VEHICLE CONTROL DEVICE

(71) Applicant: TOYOTA JIDOSHA KABUSHIKI KAISHA, Toyota-shi (JP)

(72) Inventor: Wataru KAWASHIMA, Nisshin-shi (JP)

(73) Assignee: TOYOTA JIDOSHA KABUSHIKI KAISHA, Toyota-shi (JP)

(21) Appl. No.: 18/740,529

(22) Filed: Jun. 12, 2024

(30) Foreign Application Priority Data
Nov. 10, 2023 (JP) 2023-192362

(51) Int. Cl. B60W 40/06; G06V 20/56

(52) U.S. Cl. CPC B60W 40/06; G06V 20/588; B60W 2420/403; B60W 2552/05

(57) ABSTRACT

A vehicle movement amount detection device provided in an own vehicle provided with an external sensor capable of detecting a rut uses, as a feature point, a rut included in a detection result of an external sensor before movement of the own vehicle and a rut included in a detection result of an external sensor after movement of the own vehicle while the own vehicle is traveling on an off-road, and calculates a movement amount of the own vehicle by matching a detection result of the external sensor before movement of the own vehicle with a detection result of the external sensor after movement of the own vehicle.

### CROSS-REFERENCE TO RELATED APPLICATION

This application claims priority to Japanese Patent Application No. 2023-192362 filed on Nov. 10, 2023, incorporated herein by reference in its entirety.

### BACKGROUND

### 1. Technical Field

The present disclosure relates to a vehicle movement amount detection device, and a vehicle control device.

### 2. Description of Related Art

Japanese Unexamined Patent Application Publication No. 2018-096935 (JP 2018-096935 A) describes a technique of calculating the position of a host vehicle by searching for a portion in which a first point group that constitutes a road marking extracted from a road surface image matches a first line segment extracted from map data, and searching for a portion in which a second point group that constitutes a road marking extracted from the road surface image matches a second line segment extracted from the map data.

### SUMMARY

In the technique described in JP 2018-096935 A, it is assumed that the first point group and the second point group that constitute the road markings can be extracted from the road surface image. When the host vehicle travels off road (e.g. in a desert etc.), however, a road surface image does not include road markings, even if a road surface is imaged from the host vehicle. Therefore, with the technique described in JP 2018-096935 A, the amount of movement of the host vehicle cannot be calculated as the position of the host vehicle cannot be calculated when the host vehicle travels off road.

In view of the above, an object of the present disclosure is to provide a vehicle movement amount detection device, a vehicle control device, and a program that can calculate the amount of movement of a host vehicle even when the host vehicle travels off road.

A first aspect of the present disclosure provides a vehicle movement amount detection device provided in a host vehicle that includes an external sensor capable of detecting a rut. The vehicle movement amount detection device calculates an amount of movement of the host vehicle by matching a detection result of the external sensor before the movement of the host vehicle with a detection result of the external sensor after the movement of the host vehicle using a rut included in the detection result of the external sensor before the movement of the host vehicle and a rut included in the detection result of the external sensor after the movement of the host vehicle as feature points while the host vehicle is traveling off road.

The vehicle movement amount detection device may request control for the host vehicle such that a shape of the rut included in the detection result of the external sensor is varied when the shape of the rut included in the detection result of the external sensor is not varied for a predetermined period or more.

A second aspect of the present disclosure provides a vehicle control device. The vehicle control device includes: the vehicle movement amount detection device described above; and a vehicle motion control unit that controls motion of the host vehicle such that a shape of the rut included in the detection result of the external sensor is varied when an operation corresponding to predetermined vehicle control is not performed for a certain time.

A third aspect of the present disclosure provides a vehicle control device provided in a host vehicle that includes an external sensor capable of detecting a rut. The vehicle control device includes: a vehicle movement amount calculation unit that calculates an amount of movement of the host vehicle by matching a detection result of the external sensor before the movement of the host vehicle with a detection result of the external sensor after the movement of the host vehicle using a rut included in the detection result of the external sensor before the movement of the host vehicle and a rut included in the detection result of the external sensor after the movement of the host vehicle as feature points while the host vehicle is traveling off road; and a vehicle motion control unit that controls motion of the host vehicle such that such that a shape of the rut included in the detection result of the external sensor is varied when the shape of the rut included in the detection result of the external sensor is not varied for a predetermined period or more.

A fourth aspect of the present disclosure provides a program. The program causes a processor to execute a process including calculating an amount of movement of a host vehicle by matching a detection result of the external sensor before the movement of the host vehicle with a detection result of the external sensor after the movement of the host vehicle using predetermined ruts as feature points.

The processor is provided in the host vehicle that includes an external sensor capable of detecting a rut.

The predetermined ruts include a rut included in the detection result of the external sensor before the movement of the host vehicle and a rut included in the detection result of the external sensor after the movement of the host vehicle while the host vehicle is traveling off road.

According to the present disclosure, it is possible to calculate the amount of movement of a host vehicle even when the host vehicle travels off road.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of an own vehicle 1 including a vehicle control device 13 according to a first embodiment;

FIG. 2 is a diagram for conceptually explaining an exemplary method by which the vehicle movement amount calculation unit 3C calculates the movement amount of the own vehicle 1;

FIG. 3 is a diagram of a comparative example for conceptually explaining a detection result or the like of the external sensor 11 when the host vehicle 1 travels off-road;

FIG. 4 is a diagram of an embodiment for conceptually explaining a detection result or the like of the external sensor 11 when the host vehicle 1 travels off-road;

FIG. 5 is a flowchart for describing an example of processing executed by the processor 133 of the vehicle control device 13 according to the first embodiment;

FIG. 6 is a flow chart for describing an exemplary process executed by the processor 133 of the vehicle control device 13 according to the second embodiment; and

FIG. 7 is a flowchart for describing an example of processing executed by the processor 133 of the vehicle control device 13 according to the third embodiment.

### DETAILED DESCRIPTION OF EMBODIMENTS

Embodiments of a vehicle movement amount detection device, a vehicle control device, and a program according to the present disclosure will be described below with reference to the drawings.

### First Embodiment

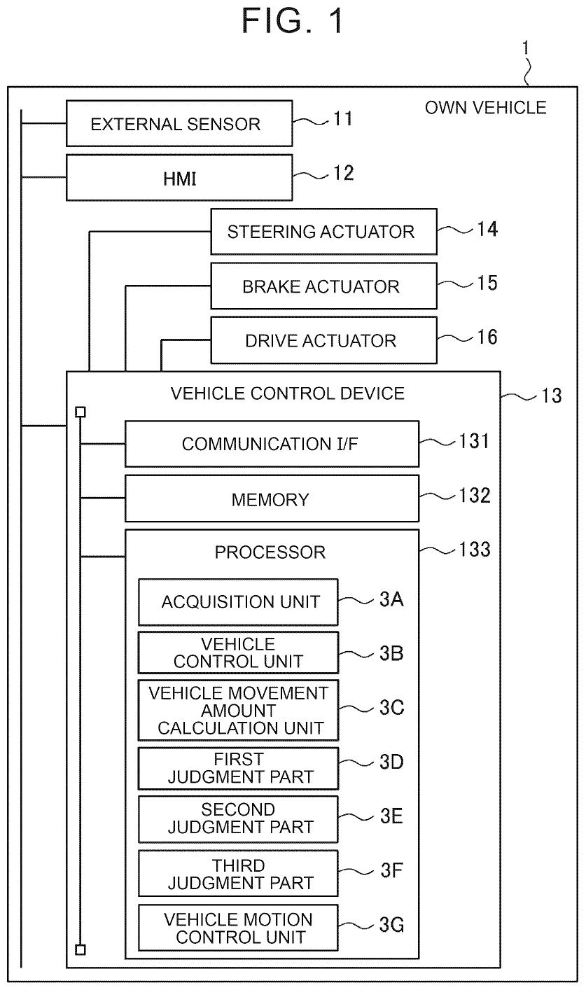

FIG. 1 is a diagram illustrating an example of a host vehicle 1 including a vehicle control device 13 according to a first embodiment.

In the embodiment illustrated in FIG. 1, the host vehicle 1 includes an external sensor 11, a human machine interface (HMI) 12, a vehicle control device 13, a steering actuator 14, a braking actuator 15, and a drive actuator 16.
The external sensor 11 is, for example, a camera or a light detection and ranging (LiDAR) that captures an image of the rear of the host vehicle 1. The external sensor 11 has a function of detecting a rut, and transmits a detection result to the vehicle control device 13. HMI 12 has a function of accepting various operations of the driver of the host vehicle 1, and transmits a signal indicating the operation of the driver of the host vehicle 1 to the vehicle control device 13.

The vehicle control device 13 is constituted by a driving support electronic control unit (ECU). The vehicle control device 13 controls the steering actuator 14, the braking actuator 15, and the drive actuator 16 on the basis of a detected signal transmitted from the external sensor 11 and a signal or the like indicating an operation of the driver of the host vehicle 1 transmitted from HMI 12. The steering actuator 14 has a function of steering the host vehicle 1. The steering actuator 14 includes, for example, a power steering system, a steer-by-wire steering system, a rear wheel steering system, and the like. The braking actuator 15 has a function of decelerating the host vehicle 1. The braking actuator 15 includes, for example, a hydraulic brake, a power regenerative brake, and the like. The drive actuator 16 has a function of accelerating the host vehicle 1. The drive actuator 16 includes, for example, engines, battery electric vehicle (EV) systems, hybrid systems, fuel cell systems, and the like.

The vehicle control device 13 is constituted by a microcomputer including a communication interface (I/F) 131, a memory 132, and a processor 133). The communication interface 131 includes interface circuitry for connecting the vehicle control device 13 to the external sensor 11, HMI 12, the steering actuator 14, the braking actuator 15, the drive actuator 16, and the like. The memory 132 stores programs and various types of data used in processing executed by the processor 133. The memory 132 also stores a detection result and the like transmitted from the external sensor 11. The processor 133 has a function as an acquisition unit 3A, a function as a vehicle control unit 3B, a function as a vehicle movement amount calculation unit 3C, a function as a first determination unit 3D, a function as a second determination unit 3E, a function as a third determination unit 3F, and a function as a vehicle motion control unit 3G.

The acquisition unit 3A acquires a detection result of the external sensor 11 (for example, a camera image indicating a rut or the like, a detection result of a LiDAR indicating a rut or the like, or the like). In addition, the acquisition unit 3A acquires an indication of the driver of the host vehicle 1 received by HMI 12. The operation of the driver of the host vehicle 1 is, for example, an operation of ON/OFF a driving support function (for example, an adaptive cruise control (ACC)), a steering operation, a brake pedal operation, an accelerator pedal operation, or the like.

The vehicle control unit 3B controls the steering actuator 14, the braking actuator 15, and the drive actuator 16 on the basis of the detection result of the external sensor 11 acquired by the acquisition unit 3A, a signal indicating the operation of the driver of the host vehicle 1, and the like.

The vehicle movement amount calculation unit 3C calculates the movement amount of the host vehicle 1 using a technique of visual odometry or LiDAR odometry based on the detection result of the external sensor 11 acquired by the acquisition unit 3A.

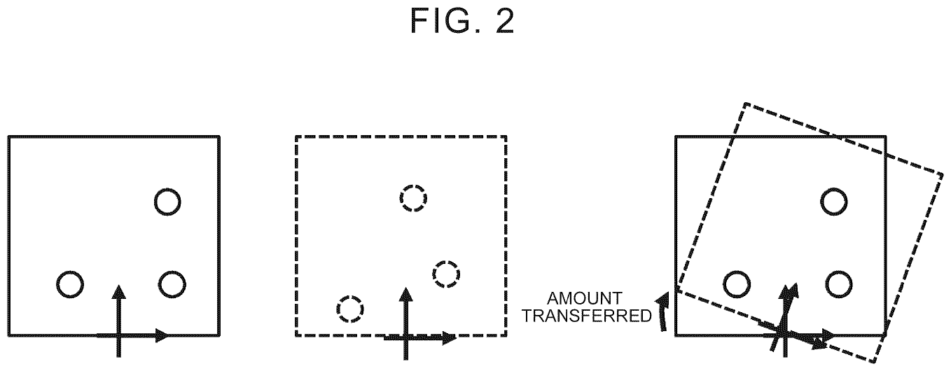

FIG. 2 is a diagram for conceptually explaining an exemplary method by which the vehicle movement amount calculation unit 3C calculates the movement amount of the host vehicle 1. Specifically, the left diagram of FIG. 2 shows the detection result of the external sensor 11 at the first time, the middle diagram of FIG. 2 shows the detection result of the external sensor 11 at the second time, and the right diagram of FIG. 2 shows a method for calculating the amount of movement of the host vehicle 1.

In the embodiment illustrated in FIG. 2, the vehicle movement amount calculation unit 3C calculates the movement amount of the host vehicle 1 (refer to the right-hand diagram in FIG. 2) in the time period from the first time to the second time. As shown in the right figure of FIG. 2, the vehicle movement amount calculation unit 3C calculates the movement amount of the host vehicle 1 (see the right figure of FIG. 2) by matching the detection result of the external sensor 11 at the first time and the detection result of the external sensor 11 at the second time using predetermined characteristic points. The predetermined feature points are three feature points included in the detection result of the external sensor 11 at the first time shown in the left figure of FIG. 2, and three feature points included in the detection result of the external sensor 11 at the second time shown in the middle figure of FIG. 2.

As illustrated in FIG. 2, when three characteristic points are included in the detection result of the external sensor 11, the vehicle movement amount calculation unit 3C can calculate the movement amount of the host vehicle 1 by using a technique of visual odometry or LiDAR odometry. On the other hand, when the host vehicle 1 is traveling on an off-road, a characteristic landmark that can be used as a feature point is not included in the detection result of the external sensor 11 in many cases. When the technique of visual odometry or LiDAR odometry is used, unless the characteristic point is included in the detection result of the external sensor 11, in principle, the detection result of the external sensor 11 before the vehicle 1 moves cannot be matched with the detection result of the external sensor 11 after the vehicle 1 moves, and the movement amount before and after the vehicle 1 moves cannot be calculated.

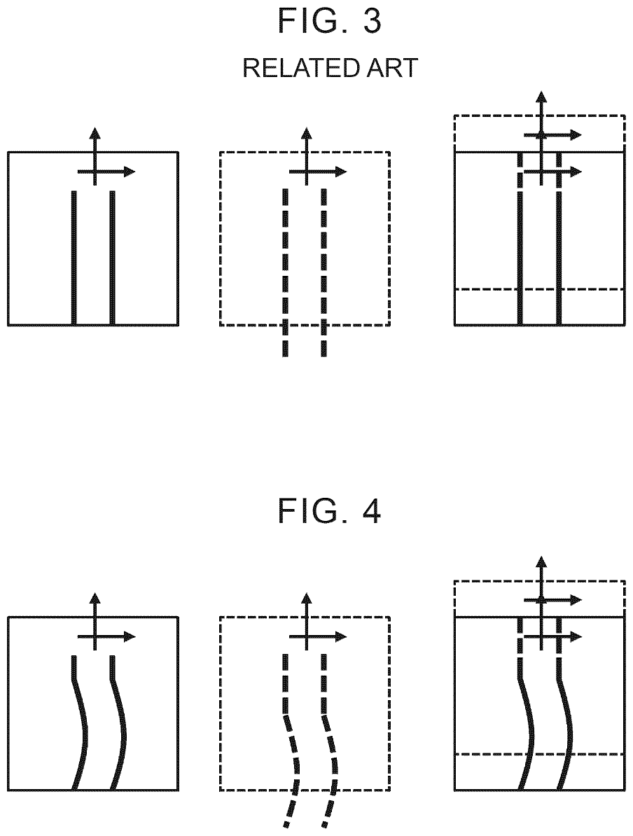

FIG. 3 and FIG. 4 are diagrams for conceptually explaining a detection result and the like of the external sensor 11 in a case where the host vehicle 1 travels off-road. Specifically, the left figure of FIG. 3, the middle figure of FIG. 3, the right figure of FIG. 3 shows an example (comparative example) in which the later-described control is not performed for allowing the vehicle movement amount calculation unit 3C to calculate the movement amount of the own vehicle 1 when the own vehicle 1 travels off-road. The left view in FIG. 4, the middle view in FIG. 4, and the right view in FIG. 4 show an example (embodiment) in which a control to be described later is performed so that the vehicle movement amount calculation unit 3C can calculate the movement amount of the host vehicle 1 when the host vehicle 1 travels off-road. The left diagram of FIG. 3 shows the detection result of the external sensor 11 at the first time of the comparative example, the middle diagram of FIG. 3 shows the detection result of the external sensor 11 at the second time of the comparative example, and the right diagram of FIG. 3 shows the calculation result of the movement amount of the host vehicle 1 in the comparative example. The left view of FIG. 4 shows the detection result of the external sensor 11 at the first time of the embodiment, the middle view of FIG. 4 shows the detection result of the external sensor 11 at the second time of the embodiment, and the right view of FIG. 4 shows the calculation result of the movement amount of the host vehicle 1 in the embodiment.

In the example (comparative example) shown in the left figure of FIG. 3, the middle figure of FIG. 3, and the right figure of FIG. 3, the vehicle control unit 3B controls the steering actuator 14, the braking actuator 15, and the drive actuator 16 so that the host vehicle 1 continues to travel straight (that is, the rut becomes straight) and the depth of the rut becomes constant continuously. Therefore, the detection result of the external sensor 11 at the first time shown in the left figure of FIG. 3 and the detection result of the external sensor 11 at the second time shown in the middle figure of FIG. 3 include only linear ruts. As a result, in the comparative example, the detection result of the external sensor 11 at the first time shown in the left figure of FIG. 3 and the detection result of the external sensor 11 at the second time shown in the middle figure of FIG. 3 cannot be matched, and the movement amount in the time period from the first time to the second time cannot be calculated. In view of this, in the example shown in FIG. 1, measures to be described later are taken.

In the embodiment illustrated in FIG. 1, the first determination unit 3D determines whether or not the driving support function (for example, ACC or the like) is ON. The second determination unit 3E determines whether or not the host vehicle 1 is traveling on an off-road based on, for example, the detection result of the external sensor 11.

In the first embodiment of the second determination unit 3E, the second determination unit 3E determines whether or not a lane (or a demarcated line defining a lane) in which the host vehicle 1 is traveling is included in, for example, a detection result of the external sensor 11. The second determination unit 3E determines that the host vehicle 1 is traveling off-road when the lane in which the host vehicle 1 is traveling (or the lane defining the lane) is not included in, for example, the detection result of the external sensor 11 (that is, when the lane cannot be recognized).

In the second embodiment of the second determination unit 3E, the second determination unit 3E determines whether or not the host vehicle 1 is traveling on an off-road, based on the traveling resistance of the host vehicle 1 or the settlement amount of the host vehicle 1.

Specifically, the second determination unit 3E calculates the assumed vehicle speed of the host vehicle 1 (vehicle speed when there is no slippage of the drive wheels with respect to the ground) based on the propulsive force of the host vehicle 1 obtained from the accelerator operation amount, the brake operation amount, the reduction ratio of the gear, and the like, and the slope of the host vehicle 1 and the ground. Further, the second determination unit 3E calculates the actual vehicle speed of the host vehicle 1 based on, for example, the rotational speed of the driven wheels of the host vehicle 1. Further, when the difference between the assumed vehicle speed of the host vehicle 1 and the actual vehicle speed of the host vehicle 1 is larger than the predetermined threshold value, the second determination unit 3E determines that the traveling resistance is large and the host vehicle 1 is traveling off-road. Further, since the traveling resistance of the host vehicle 1 increases as the settlement amount of the wheels of the host vehicle 1 increases, the second determination unit 3E determines that the host vehicle 1 is traveling off-road when the settlement amount of the wheels of the host vehicle 1 is larger than a predetermined threshold value.

In the third example of the second determination unit 3E, the second determination unit 3E determines, based on the detection result of the external sensor 11, whether or not the host vehicle 1 is traveling on the off-road by using a model obtained by performing learning using teacher data that is a data set of a detection result (e.g., a detection result of a camera image or a LiDAR) of the external sensor for learning and a label indicating whether or not the ground included in the detection result of the external sensor for learning is an off-road.

In the embodiment illustrated in FIG. 1, the third determination unit 3F determines whether or not an operation corresponding to a predetermined vehicle control is not performed for a predetermined period of time.

The “predetermined time” is a time required for the vehicle 1 to travel the largest value of the recognition distance of the external sensor 11 determined from the detection range of the angle of view and LiDAR of the camera as the external sensor 11. For example, when the recognized distance of the external sensor 11 is 100 [m] and the vehicle speed of the host vehicle 1 is 60 [km/h, the “fixed time” is 6 [sec].
Specifically, the “predetermined vehicle control” is the control of the host vehicle 1 by the vehicle control unit 3B that changes the shapes of the ruts included in the detection result of the external sensor 11.
The “predetermined vehicle control” includes a steering operation having a change amount of the steering angle equal to or greater than a predetermined threshold value. When the amount of change in the steering angle of the steering assistance is equal to or greater than the predetermined threshold value, the third determination unit 3F determines that there is an operation corresponding to the predetermined vehicle control within the predetermined time.
Further, the “predetermined vehicle control” includes a brake operation having a change amount of deceleration equal to or greater than a predetermined threshold value. When there is a braking operation in which the amount of change in the deceleration is equal to or greater than a predetermined threshold value, the third determination unit 3F determines that there is an operation corresponding to the predetermined vehicle control within a predetermined period of time.
In another example, the “predetermined vehicle control” may include an accelerator operation having an acceleration change amount equal to or greater than a predetermined threshold value. In this case, the third determination unit 3F determines that there is an operation corresponding to the predetermined vehicle control within a predetermined period of time when there is an accelerator operation in which the acceleration change amount is equal to or greater than a predetermined threshold value.

In the example illustrated in FIG. 1, when the operation corresponding to the above-described “predetermined vehicle control” is not “predetermined time”, the vehicle motion control unit 3G executes predetermined vehicle motion control (that is, controls the motion of the own vehicle 1) so that the shape of the rut included in the detection result of the external sensor 11 changes without the need for HMI 12 to accept the operation of the driver of the own vehicle 1.

Specifically, the “predetermined vehicle motion control” is control of the host vehicle 1 by the vehicle motion control unit 3G that changes (forcibly) the shape of the rut included in the detection result of the external sensor 11 without requiring HMI 12 to accept the operation of the driver of the host vehicle 1.

The “predetermined vehicle motion control” includes a steering operation having a change amount of the steering angle equal to or greater than a predetermined threshold value. When the driving support function is ON, the vehicle motion control unit 3G executes a steering operation having a change in the steering angle equal to or greater than a predetermined threshold value, so that a rut having a characteristic point is included in the detection result of the external sensor 11. As a result, the vehicle movement amount calculation unit 3C can calculate the movement amount of the host vehicle 1 in the time period from the first time to the second time by matching the detection result of the external sensor 11 at the first time (the trajectory of the rut) and the detection result of the external sensor 11 at the second time (the trajectory of the rut) using the predetermined feature point. The feature points of the predetermined rut are the feature points of the rut included in the detection result of the external sensor 11 at the first time and the feature points of the rut included in the detection result of the external sensor 11 at the second time.

Further, the “predetermined vehicle motion control” includes a brake operation having a change amount of deceleration equal to or greater than a predetermined threshold value. When the driving support function is ON, the vehicle motion control unit 3G executes a braking operation having a change amount of the deceleration equal to or greater than a predetermined threshold, so that a rut having a feature point (a rut having a change in depth) is included in the detection result of the external sensor 11. As a result, the vehicle movement amount calculation unit 3C can calculate the movement amount of the host vehicle 1 in the time period from the first time to the second time by matching the detection result of the external sensor 11 at the first time and the detection result of the external sensor 11 at the second time using the predetermined characteristic point. The feature points of the predetermined rut are the feature points of the rut included in the detection result of the external sensor 11 at the first time and the feature points of the rut included in the detection result of the external sensor 11 at the second time. In another example, the “predetermined vehicle motion control” may include an accelerator operation having an acceleration change amount equal to or greater than a predetermined threshold value. In this case, when the driving support function is ON, the vehicle motion control unit 3G executes an accelerator operation having a change in acceleration equal to or greater than a predetermined threshold, so that a rut having a feature point (a rut having a change in depth) is included in the detection result of the external sensor 11.

In the example (embodiment) shown in the left figure of FIG. 4, the middle figure of FIG. 4, and the right figure of FIG. 4, the steering actuator 14 is controlled so that the vehicle motion control unit 3G changes the shape of the rut included in the detection result of the external sensor 11 when the driving support function (for example, ACC or the like) is ON, the host vehicle 1 is traveling on an off-road, and the above-described operation corresponding to “predetermined vehicle control” is not “fixed time”. Therefore, the feature point of the rut is included in the detection result of the external sensor 11 at the first time shown in the left figure of FIG. 4, and the feature point of the rut is also included in the detection result of the external sensor 11 at the second time shown in the right figure of FIG. 4. Consequently, the vehicle movement amount calculation unit 3C can calculate the movement amount of the host vehicle 1 in the time period from the first time to the second time. The vehicle movement amount calculation unit 3C can calculate the movement amount of the host vehicle 1 by matching the detection result of the external sensor 11 at the first time and the detection result of the external sensor 11 at the second time using the characteristic point of the predetermined rut, as shown in the right figure of FIG. 4. The feature points of the predetermined rut are the feature points of the rut included in the detection result of the external sensor 11 at the first time shown in the left figure of FIG. 4, and the feature points of the rut included in the detection result of the external sensor 11 at the second time shown in the middle figure of FIG. 4.

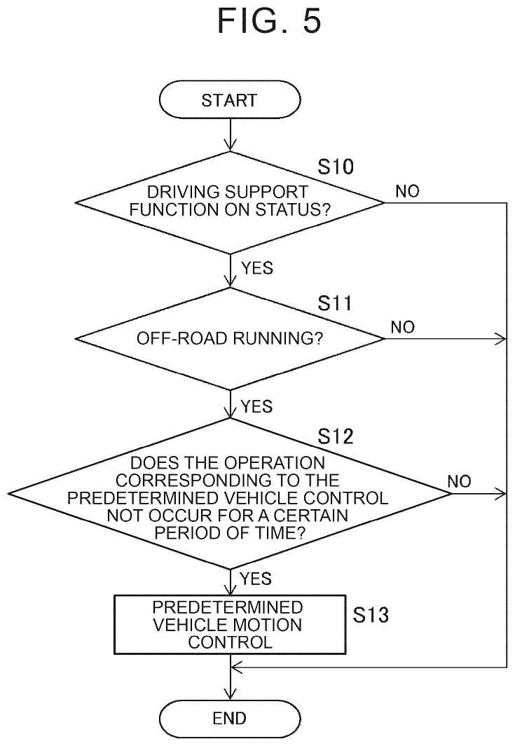

FIG. 5 is a flowchart for describing an example of processing executed by the processor 133 of the vehicle control device 13 according to the first embodiment.

In the embodiment illustrated in FIG. 5, in S10, the first determination unit 3D determines whether or not the driving support function is ON. In the case of YES, the process proceeds to S11, and in the case of NO, the process illustrated in FIG. 5 is ended.
In S11, the second determination unit 3E determines whether or not the host vehicle 1 is traveling on an off-road. In the case of YES, the process proceeds to S12, and in the case of NO, the process illustrated in FIG. 5 is ended.
In S12, the third determination unit 3F determines whether or not an operation corresponding to the above-described “predetermined vehicle control” is not the above-described “predetermined period”. In the case of YES, the process proceeds to S13, and in the case of NO, the process illustrated in FIG. 5 is ended.
In S13, the vehicle motion control unit 3G executes the above-described “predetermined vehicle motion control”.

In the host vehicle 1 including the vehicle control device 13 of the first embodiment, while the host vehicle 1 is traveling off-road, the vehicle movement amount calculation unit 3C functioning as the vehicle movement amount detection device uses a predetermined rut as a feature point, and calculates the movement amount of the host vehicle 1 by matching the detection result of the external sensor 11 before the movement of the host vehicle 1 with the detection result of the external sensor 11 after the movement of the host vehicle 1, for example, as shown in the right figure of FIG. 4. The predetermined rut is, for example, a rut included in the detection result of the external sensor 11 before movement of the host vehicle 1 shown in the left figure of FIG. 4, and a rut included in the detection result of the external sensor 11 after movement of the host vehicle 1 shown in the middle figure of FIG. 4. Therefore, in the host vehicle 1 including the vehicle control device 13 of the first embodiment, it is possible to calculate the movement amount of the host vehicle 1 even when the host vehicle 1 travels off-road.

### Second Embodiment

The host vehicle 1 including the vehicle control device 13 of the second embodiment is configured in the same manner as the host vehicle 1 including the vehicle control device 13 of the first embodiment described above, except for the points described later.

As described above, in the host vehicle 1 to which the vehicle control device 13 according to the first embodiment is applied, the third determination unit 3F determines whether or not the manipulation corresponding to the predetermined vehicle control is not performed for a certain period of time.

On the other hand, in the host vehicle 1 to which the vehicle control device 13 of the second embodiment is applied, the third determination unit 3F determines whether or not the shape of the rut included in the detection result of the external sensor 11 does not change over a predetermined period or more. When the shape of the rut included in the detection result of the external sensor 11 does not change for a predetermined period or longer, the vehicle motion control unit 3G executes predetermined vehicle motion control (that is, controls the motion of the own vehicle 1) so that the shape of the rut included in the detection result of the external sensor 11 changes without requiring HMI 12 to accept the operation of the driver of the own vehicle 1.

Specifically, in the host vehicle 1 to which the vehicle control device 13 of the second embodiment is applied, when the shape of the rut included in the detection result of the external sensor 11 does not change over a predetermined period or more, the vehicle movement amount calculation unit 3C functioning as the vehicle movement amount detection device cannot calculate the movement amount of the host vehicle 1. Therefore, the vehicle motion control unit 3G is required to control the host vehicle 1 so that the shape of the rut included in the detection result of the external sensor 11 changes.

The vehicle motion control unit 3G executes predetermined vehicle motion control so that the shape of the rut included in the detection result of the external sensor 11 changes in response to a request from the vehicle movement amount calculation unit 3C.

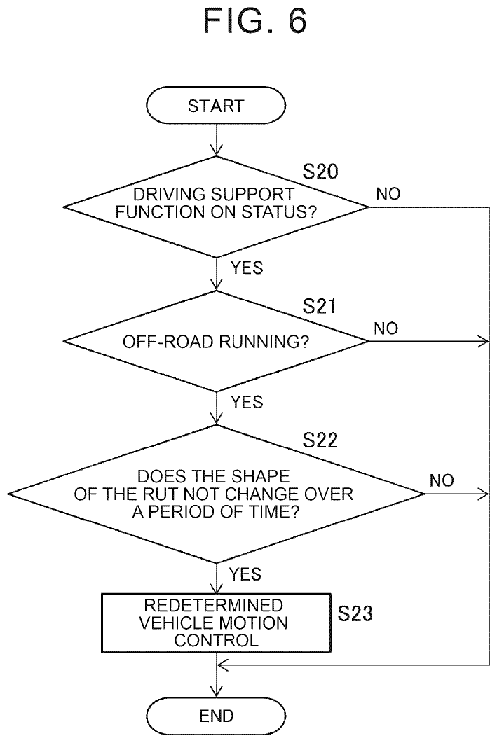

FIG. 6 is a flowchart for describing an example of processing executed by the processor 133 of the vehicle control device 13 according to the first embodiment. In the embodiment illustrated in FIG. 6, in S20, the first determination unit 3D determines whether or not the driving support function is ON. In the case of YES, the process proceeds to S21, and in the case of NO, the process illustrated in FIG. 6 is ended.

In S21, the second determination unit 3E determines whether or not the host vehicle 1 is traveling on an off-road. In the case of YES, the process proceeds to S22, and in the case of NO, the process illustrated in FIG. 6 is ended.
In S22, the third determination unit 3F determines whether or not the shape of the rut included in the detection result of the external sensor 11 does not change over a predetermined period or more. In the case of YES, the process proceeds to S23, and in the case of NO, the process illustrated in FIG. 6 is ended.
In S23, the vehicle motion control unit 3G executes predetermined vehicle motion control.

### Third Embodiment

The host vehicle 1 including the vehicle control device 13 of the third embodiment is configured in the same manner as the host vehicle 1 including the vehicle control device 13 of the first embodiment described above, except for the points described later.

As described above, in the host vehicle 1 to which the vehicle control device 13 of the first embodiment is applied, the vehicle control device 13 is configured by a driving support ECU.

On the other hand, in the host vehicle 1 to which the vehicle control device 13 of the third embodiment is applied, the vehicle control device 13 is configured by an autonomous driving ECU.

As described above, in the host vehicle 1 to which the vehicle control device 13 according to the first embodiment is applied, the acquisition unit 3A acquires a signal indicating an operation of ON/OFF of the driver's driving support function of the host vehicle 1 received by HMI 12.

On the other hand, in the host vehicle 1 to which the vehicle control device 13 according to the third embodiment is applied, the acquisition unit 3A acquires a signal indicating an operation of ON/OFF the autonomous driving function of the driver of the host vehicle 1 received by HMI 12. When the autonomous driving function is ON, the vehicle control unit 3B controls the steering actuator 14, the braking actuator 15, and the drive actuator 16 on the basis of the position information of the host vehicle 1, the travel plan of the autonomous driving, and the like without requiring HMI 12 to accept the operation of the driver of the host vehicle 1.

As described above, in the host vehicle 1 to which the vehicle control device 13 of the first embodiment is applied, the first determination unit 3D determines whether or not the driving assistance function is ON.

On the other hand, in the host vehicle 1 to which the vehicle control device 13 according to the third embodiment is applied, the first determination unit 3D determines whether or not the autonomous driving function is ON.

As described above, in the host vehicle 1 to which the vehicle control device 13 according to the first embodiment is applied, the “predetermined vehicle control” includes a steering operation having a change amount of the steering angle equal to or greater than a predetermined threshold value.

On the other hand, in the host vehicle 1 to which the vehicle control device 13 according to the third embodiment is applied, the “predetermined vehicle control” includes the vehicle control based on the route plan of the autonomous driving in which the amount of change in the curvature is equal to or greater than a predetermined value.

As described above, in the host vehicle 1 to which the vehicle control device 13 of the first embodiment is applied, the “predetermined vehicle control” includes a brake operation having a change amount of deceleration equal to or greater than a predetermined threshold value.

On the other hand, in the host vehicle 1 to which the vehicle control device 13 according to the third embodiment is applied, the “predetermined vehicle control” includes the vehicle control based on the speed plan of the autonomous driving in which the amount of change in the deceleration is equal to or greater than a predetermined value.

As described above, in the host vehicle 1 to which the vehicle control device 13 according to the first embodiment is applied, the “predetermined vehicle motion control” includes a steering operation having a change amount of the steering angle equal to or more than a predetermined threshold value.

On the other hand, in the host vehicle 1 to which the vehicle control device 13 according to the third embodiment is applied, the “predetermined vehicle motion control” includes setting a route plan for autonomous driving in which the amount of change in curvature is equal to or greater than a certain value.

As described above, in the host vehicle 1 to which the vehicle control device 13 according to the first embodiment is applied, the “predetermined vehicle motion control” includes a brake operation having a change amount of deceleration equal to or greater than a predetermined threshold value.

On the other hand, in the host vehicle 1 to which the vehicle control device 13 according to the third embodiment is applied, the “predetermined vehicle motion control” includes setting a speed plan for autonomous driving in which the amount of change in deceleration is equal to or greater than a certain value.

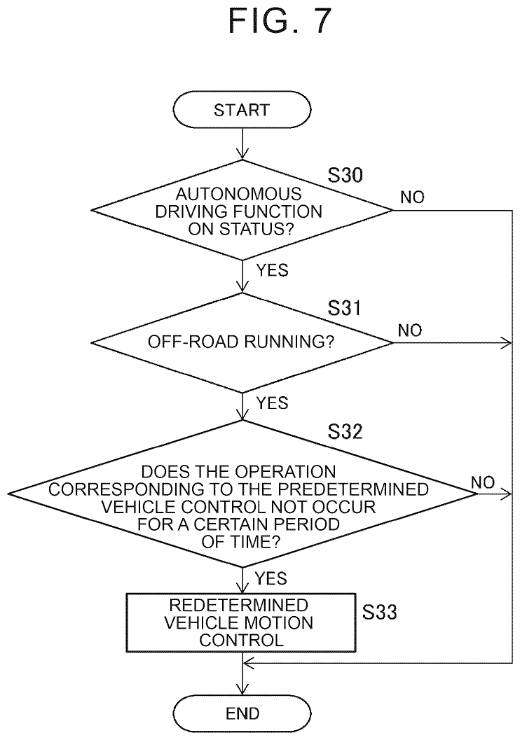

FIG. 7 is a flowchart for describing an example of processing executed by the processor 133 of the vehicle control device 13 according to the third embodiment. In the embodiment illustrated in FIG. 7, in S30, the first determination unit 3D determines whether or not the autonomous driving function is ON. If YES, the process proceeds to S31, and if NO, the process illustrated in FIG. 7 is terminated.

In S31, the second determination unit 3E determines whether or not the host vehicle 1 is traveling on an off-road. If YES, the process proceeds to S32, and if NO, the process illustrated in FIG. 7 is terminated.
In S32, the third determination unit 3F determines whether or not an operation corresponding to the predetermined vehicle control is not performed for a predetermined period of time. If YES, the process proceeds to S33, and if NO, the process illustrated in FIG. 7 is terminated. In S33, the vehicle motion control unit 3G executes predetermined vehicle motion control.

### Fourth Embodiment

The host vehicle 1 including the vehicle control device 13 of the fourth embodiment is configured in the same manner as the host vehicle 1 including the vehicle control device 13 of the third embodiment described above, except for the points described later.

In the host vehicle 1 to which the vehicle control device 13 according to the third embodiment is applied, the third determination unit 3F determines whether or not the manipulation corresponding to the predetermined vehicle control is not performed for a predetermined period of time.

On the other hand, in the host vehicle 1 to which the vehicle control device 13 according to the fourth embodiment is applied, the third determination unit 3F determines whether or not the shape of the rut included in the detection result of the external sensor 11 does not change over a predetermined period or more. When the shape of the rut included in the detection result of the external sensor 11 does not change for a predetermined period or longer, the vehicle motion control unit 3G executes predetermined vehicle motion control (setting of a route plan, a speed plan, or the like) so that the shape of the rut included in the detection result of the external sensor 11 changes without the need for HMI 12 to accept the operation of the driver of the own vehicle 1.

Specifically, in the host vehicle 1 to which the vehicle control device 13 of the fourth embodiment is applied, when the shape of the rut included in the detection result of the external sensor 11 does not change over a predetermined period or more, the vehicle movement amount calculation unit 3C functioning as the vehicle movement amount detection device cannot calculate the movement amount of the host vehicle 1. Therefore, the vehicle motion control unit 3G is required to control the host vehicle 1 so that the shape of the rut included in the detection result of the external sensor 11 changes.

The vehicle motion control unit 3G executes predetermined vehicle motion control (setting of a route plan, a velocity plan, and the like) so that the shape of the rut included in the detection result of the external sensor 11 changes in response to a request from the vehicle movement amount calculation unit 3C.

As described above, the embodiments of the vehicle movement amount detection device, the vehicle control device, and the program of the present disclosure have been described with reference to the drawings, but the vehicle movement amount detection device, the vehicle control device, and the program of the present disclosure are not limited to the above-described embodiments, and can be appropriately modified without departing from the spirit of the present disclosure. The configuration of each example of the above-described embodiment may be combined as appropriate. In the above-described embodiments, the process performed in the vehicle control device 13 (the driving support ECU or the autonomous driving ECU) is described as a software process performed by executing a program. The process performed in the vehicle control device 13 may be a process performed by hardware. Alternatively, the process performed in the vehicle control device 13 may be a process in which both software and hardware are combined. Further, a program (a program for realizing the function of the processor 133 of the vehicle control device 13) stored in the memory 132 of the vehicle control device 13 may be provided and distributed by being recorded in a computer-readable storage medium such as a semiconductor memory, a magnetic recording medium, an optical recording medium, or the like.

What is claimed is:

1. A vehicle movement amount detection device provided in a host vehicle that includes an external sensor capable of detecting a rut, wherein an amount of movement of the host vehicle is calculated by matching a detection result of the external sensor before the movement of the host vehicle with a detection result of the external sensor after the movement of the host vehicle using a rut included in the detection result of the external sensor before the movement of the host vehicle and a rut included in the detection result of the external sensor after the movement of the host vehicle as feature points while the host vehicle is traveling off road.

2. The vehicle movement amount detection device according to claim 1, wherein control for the host vehicle is requested such that a shape of the rut included in the detection result of the external sensor is varied when the shape of the rut included in the detection result of the external sensor is not varied for a predetermined period or more.

3. A vehicle control device comprising:
the vehicle movement amount detection device according to claim 1; and
a vehicle motion control unit that controls motion of the host vehicle such that a shape of the rut included in the detection result of the external sensor is varied when an operation corresponding to predetermined vehicle control is not performed for a certain time.

4. A vehicle control device provided in a host vehicle that includes an external sensor capable of detecting a rut, the vehicle control device comprising:
a vehicle movement amount calculation unit that calculates an amount of movement of the host vehicle by matching a detection result of the external sensor before the movement of the host vehicle with a detection result of the external sensor after the movement of the host vehicle using a rut included in the detection result of the external sensor before the movement of the host vehicle and a rut included in the detection result of the external sensor after the movement of the host vehicle as feature points while the host vehicle is traveling off road; and
a vehicle motion control unit that controls motion of the host vehicle such that such that a shape of the rut included in the detection result of the external sensor is varied when the shape of the rut included in the detection result of the external sensor is not varied for a predetermined period or more.
